(19) United States
(12) Patent Application Publication
(10) Pub. No.: US 2025/0196544 A1
(43) Pub. Date: Jun. 19, 2025

(54) METHOD AND SYSTEM FOR DETECTING THE END OF LIFE OF A TYRE

(71) Applicant: The Swatch Group Research and Development Ltd, Marin (CH)

(72) Inventor: Jérémie JACCARD, Chavannes-Renens (CH)

(73) Assignee: The Swatch Group Research and Development Ltd, Marin (CH)

(21) Appl. No.: 18/812,106

(22) Filed: Aug. 22, 2024

(30) Foreign Application Priority Data
Dec. 14, 2023 (EP) 23216681.9

(51) Int. Cl. B60C 11/24

(52) U.S. Cl. CPC B60C 11/243

(57) ABSTRACT

A tyre monitoring system (1) for a vehicle for detecting the end of life of the tyre (2). The system (1) includes: a first and a second tyre wear indicator integrated into the tyre (2) or placed thereon; the first and the second tyre wear indicators being spatially separated along the circumference of the tyre, and the indicators (4) comprising at least one part which is harder than the tread (3) of the tyre; an accelerometer (7) integrated into the tyre (2), or placed thereon, and arranged to generate an accelerometer signal that is arranged to indicate a vibration of the tyre (2) when the indicators come into contact with a road surface as a result of sufficient wear of the tyre (2); and a detection algorithm arranged to analyse the accelerometer signal, thereby detecting tyre vibration indicating the end of the life of the tyre (2).

### REFERENCE TO RELATED APPLICATIONS

This application claims priority from European Patent Application No. 23216681.9 filed on Dec. 14, 2023. The entire content of the priority application is incorporated herein by reference

### TECHNICAL FIELD

The present invention relates to the field of tyre monitoring systems. More specifically, it relates to a system and method for detecting the end of life of a motor vehicle tyre.

### PRIOR ART

Tyre monitoring systems have become essential components in the modern automotive industry, and are intended to improve road safety and extend tyre life. Currently, most of these systems focus on detecting tyre pressure, but few offer effective solutions for monitoring tyre wear.

Accurate detection of tyre wear is crucial to ensuring optimum performance, maximum fuel economy and enhanced safety. Existing methods for monitoring tyre wear are often have limited accuracy and reliability. Moreover, most existing systems, although functional, are structurally complex.

These complex systems often comprise a multitude of components, such as sophisticated sensors, extensive communication networks and large data processing units. This structural complexity not only makes installation and maintenance costly, but can also lead to operational problems due to the potential failure of one of these many elements.

### SUMMARY OF THE INVENTION

One objective of the present invention is to overcome at least some of the drawbacks identified above relating to tyre monitoring systems.

According to a first aspect, the invention provides a tyre monitoring system for detecting the end of life of a tyre of a vehicle as set out in claim 1.

The present invention offers numerous advantages over existing tyre monitoring systems, highlighting its structural simplicity, ease of integration with existing tyres, and its reliable ability to detect a tyre's end of life. More specifically, in contrast to existing tyre monitoring systems, the present invention is distinguished by its structural simplicity. By reducing the number of components required, it not only simplifies the manufacturing process, but also offers a more cost-effective solution in terms of production and maintenance costs. This increased simplicity contributes to greater operational reliability, by minimising the risk of failure due to excessive complexity. Moreover, the second advantage of the present invention is its ability to be easily integrated with existing tyres already on the market. Thanks to its design, the monitoring system according to the present invention can be effectively installed on a variety of tyres, thus offering flexibility of use on different types of vehicle, such as motor vehicles. This ease of integration reduces compatibility constraints and broadens the scope of application of the invention. The present invention also solves the challenge of accurately detecting the end of life of tyres. The system according to the present invention reliably monitors tyre wear, allowing immediate detection as soon as the tyre has reached its safe use limit. This feature thus contributes to improved road safety.

According to a second aspect, the invention provides a method for detecting the end of life of a tyre of a vehicle as set out in claim 15.

Other aspects of the invention are set out in the accompanying dependent claims.

### DESCRIPTION OF THE DRAWINGS

Further features and advantages of the invention will become apparent from the following description of a non-limiting embodiment, given with reference to the accompanying drawings, in which:

FIG. 1 illustrates a tyre monitoring system according to an example of the present invention;

FIG. 2 shows a cross-sectional view of a tyre taken along the line A-A as shown in FIG. 1; and

FIG. 3 shows an example of the signal emitted by an accelerometer of the tyre monitoring system.

### DETAILED DESCRIPTION OF A PREFERRED EMBODIMENT

An embodiment of the present invention will be described in detail with reference to the accompanying drawings. Identical or corresponding functional and structural elements appearing in different drawings are given the same reference numerals. As used herein, “and/or” designates one or more elements of the list joined by “and/or”. For example, “x and/or y” refers to any element in the set of three elements {(x), (y), (x, y)}. In other words, “x and/or y” means “one or both of x and y”. As another example, “x, y and/or z” means any element of the set of seven elements {(x), (y), (z), (x, y), (x, z), (y, z), (x, y, z)}. In other words, “x, y and/or z” means “one or more of x, y and z”. Moreover, the term “comprise” is used herein as an open-ended term. This means that the object includes all of the elements mentioned, but can also include additional elements not mentioned. Thus, the word “comprise” is interpreted in the broadest sense of “include” or “contain”.

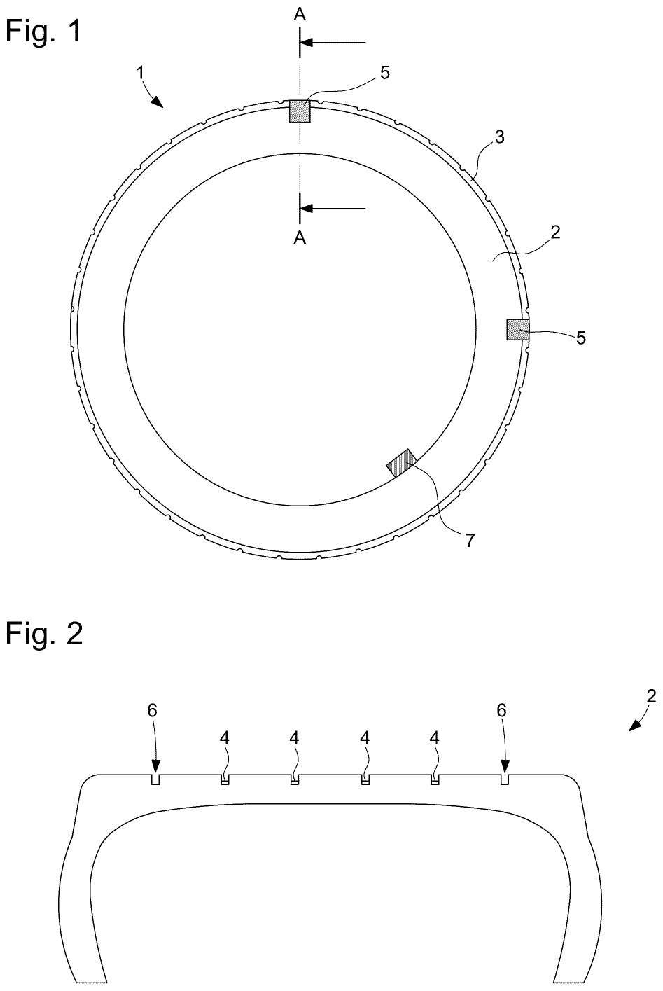

FIG. 1 shows a side view of a tyre monitoring system 1 comprising, inter alia, a car tyre 2 whose tread 3 is arranged to be in contact with a road surface (not shown). FIG. 2 shows a sectional view of the tyre 2 taken along the line A-A as shown in FIG. 1. FIG. 2 also shows a tyre wear indicator 4, also referred to as a “tread wear indicator” or “tread depth indicator”. A tyre wear indicator on a conventional tyre is a feature that serves as a visual indication of the remaining tread depth. The indicator can thus be integrated into, or placed on, the tyre. Tread depth is important for maintaining traction, roadholding and overall safety, especially in wet or slippery conditions. Tyre wear indicators are intended to help drivers assess when it's time to replace their tyres.

According to the present invention, the tyre 2 comprises at least two tyre wear indicators 4 placed at two separate locations on the tyre. FIG. 1 shows a first indicator region or zone 5 and a second indicator region or zone 5, which are spatially separated from each other along the circumference of the tyre 2. In the present example, the tyre comprises two tyre wear indicators 4 spatially separated from each other along the circumference of the tyre 2. In the present example, the tyre wear indicators are small, raised rubber bridges or bars which are placed around the circumference of the tyre and which, in this example, are arranged perpendicular to the tread pattern of the tyre. The tyre wear indicators are, in this example, positioned in one or more grooves 6 in the tyre tread pattern. The grooves extend longitudinally along the circumference of the tyre. Alternatively or additionally, the indicators 4 can be located in a groove of the tread pattern. They are typically positioned at a depth corresponding to the legal minimum tread depth for safe driving. In many regions, the legal minimum tread depth is around 1.6 millimetres. If the tyre has more than two indicators, they can be placed at regular or irregular intervals around the circumference of the tyre.

As the tyre tread wears through normal use, the height of the tyre rubber decreases. When the depth of the tread reaches a certain point, the wear indicators become level with the rest of the tread, i.e. the tread chape 3, and are thus flush with the tread, creating a visual signal. In other words, when the tyre is worn to the point where these indicators are level with the rest of the tread, this indicates that the tyre has reached the minimum legal tread depth and that it is time to replace it. The tyre has thus reached the end of its life.

According to the present invention, the first indicator 4 is characterised by a first hardness, the second indicator 4 is characterised by a second hardness, and the tread is characterised by a third hardness, the first and second hardnesses being greater than the third hardness. More specifically, the first hardness and/or the second hardness is/are at least 5% or more specifically at least 15% or 30% greater than the third hardness. In other words, the tyre wear indicators are slightly harder or more solid than the tread and/or the indicators have different mechanical properties to the tread. This means that once the tyre has worn sufficiently for the tyre wear indicators to come into contact with the road surface, the indicators wear more slowly than the tread, thus generating a vibration as the tyre rotates on the road surface. This vibration is not perceptible to the user and does not affect vehicle safety. However, even if the indicators wear at the same speed as the tread, the solution proposed by the present invention still works. In theory, the simple fact that the indicators are harder could be detected by an accelerometer 7 as explained below.

The solidification of tyre wear indicators could be achieved, for example, using a resin applied after the tyre has been manufactured or developed by a potential partner tyre manufacturer. The resin applied to a surface forms a coating or a material coating that contains a resinous substance. The resin used in this context is often a polymer substance which, when applied to a surface, creates a harder or protective layer. This type of resin is typically liquid at the time of application, but then hardens to form a solid, resistant coating. Thus a coating, such as an epoxy coating, can be achieved using resins to create a durable, wear-resistant surface.

Another approach could be to overmould the tyre wear indicator zones during tyre manufacture.

A third approach could have a tyre core, i.e. the inner part of the tyre, made of a rubber/tyre material with different mechanical properties to the tread. The core forming the tyre wear indicator would thus be harder than the tread. This difference should make it possible to have a different signature once the tread is worn. According to this alternative embodiment, the first indicator and/or the second indicator thus forms/form an element inside the tyre material and which is not exposed on the tread 3 when the tyre 2 is in a new state.

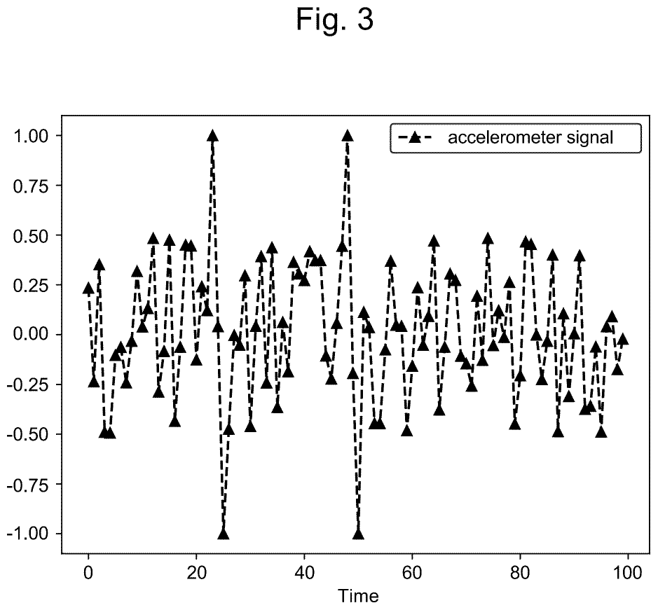

The tyre monitoring system 1 further comprises an accelerometer 7, which is arranged to sense a slight, periodic vibration when the wear indicators are reached due to tread wear. The accelerometer is connected to, or comprises, an energy-supplying element, such as a battery, etc. FIG. 3 shows the signal generated by the accelerometer. This signal can be referred to as the accelerometer signal. The X axis represents time, whereas the Y axis represents the amplitude of the signal. Two high peaks or spikes are clearly visible, resulting from the contact of the two tyre wear indicators with the road surface. The signal shown in the figure corresponds to one complete revolution of the tyre. The two peaks are repeated at regular intervals as the tyre rotates, assuming that the vehicle speed remains constant. The indicators must thus be sufficiently hard and resistant to be detected by the accelerometer, but sufficiently flexible not to be detected by the vehicle user, while taking into account environmental and safety constraints.

The accelerometer 7 can be placed in virtually any position on the tyre. For example, it can be integrated into the valve. Some tyre valves in the prior art include a tyre pressure monitoring system. In such a case, the accelerometer 7 can be optionally integrated into the tyre pressure monitoring system. According to an alternative embodiment, the accelerometer 7 can be placed, for example, on an inner or outer side face of the tyre.

The tyre monitoring system 1 further comprises an analysis circuit or microcontroller implementing a detection algorithm arranged to analyse the accelerometer signal, and which can be integrated into the accelerometer or it can be provided in the form of an autonomous element, such as a central system of the vehicle, configured to communicate for example wirelessly with the accelerometer. If the algorithm is too complicated to integrate into the accelerometer, a solution could be provided where the raw data is transmitted to the central system, which has greater computing power and which would carry out the detection. This solution could be envisaged because detection does not need to be carried out very often, given that a tyre typically wears out rather slowly. If the detection system is integrated into the central system, it is also possible to link the measurement frequency to the number of kilometres travelled in order to save energy and better target the critical period. The detection algorithm can be based on a frequency analysis. For example, the Fast Fourier Transform (FFT) can extract a coherent frequency and phase corresponding to the distribution of tyre wear indicators on the tyre, thereby rejecting a simple vibration due to a pebble stuck in a groove. The FFT is an algorithm for computing the discrete Fourier transform (DFT). The phase between two signals is a measure of the relative time shift or displacement of their waveforms. The phase is often measured in degrees or radians and represents the fraction of a cycle that has elapsed.

The accelerometer signal is arranged to indicate a vibration of the tyre 2 when the indicators 4 come into contact with a road surface as a result of sufficient tyre wear. The accelerometer signal has a set of features, such as a set of peaks, indicating the vibration of the tyre 3. The detection algorithm is arranged to analyse the accelerometer signal and identify features, such as peaks, thereby detecting tyre vibration indicating the end of tyre life.

In order to reliably reject a vibration caused by a pebble, the angular separation of the two indicators 4 on the circumference of the tyre 2 deviates from 180 degrees. More specifically, the angular separation deviates from 180 degrees by at least 10 degrees, or to be more precise by at least 20 degrees or 30 degrees. The angle of separation of two points along the circumference of the tyre is referred to as the “centre angle”. This angle measures the angular separation between two radii drawn from the centre of the tyre (which is a circle) to the two indicators on the circumference. In other words, it is the angle formed by the intersection of the lines running from the centre to the two points (indicators) on the circle. Preferably, the two indicators 4 are thus not diametrically opposite. In this specific example, the angular separation between the two indicators is substantially 90 degrees. It should be noted that the 180 angular separation of the two indicators would lead to an accelerometer signal where the peaks would repeat at regular intervals assuming that the speed “V” of the vehicle is constant. A similar signal could be generated by a pebble when stuck in the tyre tread if the vehicle speed is V×2.

The detection algorithm could alternatively or additionally be an artificial intelligence network, such as an artificial neural network. This network could first be trained using vibration training data to train the network to correctly detect particular vibration patterns from the accelerometer signal, which can be relatively noisy. Thus, the algorithm forms an intelligent algorithm. It is thus possible that no peak is clearly visible in the accelerometer signal, but that the neural network is still able to detect the end of life of the tyre based on a signal that appears to be completely noisy.

Moreover, the detection algorithm could alternatively or additionally be or comprise a filter, such as a Kalman filter, which is a signal processing algorithm used to estimate the state of a dynamic system from a sequence of noisy observations. To correctly extract the peaks from the accelerometer signal, one or more criteria can be defined for extracting the peaks from the signal. For example, if the peaks are associated with state values that exceed a threshold, they can be identified by monitoring these values.

The tyre monitoring system 1 can be arranged to communicate, for example wirelessly, with a control system or central system of the vehicle so that the system can alert the driver as soon as the end of life of one or more tyres has been detected. This event can also be recorded in the control system, central system or elsewhere so that the event can be inspected at a later date. The alert can be displayed on one or more of the vehicle's screens and/or an acoustic alert can be emitted.

According to an alternative embodiment of the present invention, the tyre monitoring system 1 further comprises one or more gyroscopes and/or gyrometers, giving the angular velocity of the tyre. The system would thus comprise an inertial measurement unit (“IMU”). According to this alternative embodiment, the gyroscope would be able to help detect the end of life of the tyre.

In view of the above, compared to tyre monitoring systems of the prior art, one of the main advantages of the present invention lies in the fact that it adds the functionality of detecting the end of life of a tyre with very few additional means compared to what already exists in a modern tyre.

The present invention further relates to a method for detecting the end of life of a tyre 2 of a vehicle using the tyre monitoring system as explained above. The method comprises the following steps: analysing, using the detection algorithm, the accelerometer signal and detecting all of the peaks corresponding to the vibration of the tyre 2 and representative of the end of life of the tyre; and transmitting the result of the detection by wireless communication means to the autonomous control module.

Although the invention has been illustrated and described in detail in the drawings and the above description, such an illustration and description are to be considered illustrative or exemplary and not restrictive, whereby the invention is not limited to the disclosed embodiment. Other embodiments and alternatives are understood, and can be carried out by a person skilled in the art when implementing the claimed invention, on the basis of a study of the drawings, the description and the accompanying claims.

In the claims, the word “comprising” does not exclude other elements or steps, and the indefinite article “one” or “a” does not exclude a plurality. The mere fact that different features are set out in mutually different dependent claims does not indicate that a combination of those features cannot be used advantageously. Any reference signs in the claims should not be construed as limiting the scope of the invention.

1. A tyre monitoring system (1) for a vehicle for detecting the end of life of the tyre (2), the system (1) comprising:
a first tyre wear indicator (4) integrated into the tyre (2) or placed thereon;
a second tyre wear indicator (4) integrated into the tyre, or placed thereon, the first indicator (4) and the second indicator (4) being spatially separated along the circumference of the tyre, and the indicators (4) comprising at least one part which is harder than the tread (3) of the tyre (2);
an accelerometer (7) integrated into the tyre (2), or placed thereon, and arranged to generate an accelerometer signal that is arranged to indicate a vibration of the tyre (2) when the indicators (4) come into contact with a road surface as a result of sufficient wear of the tyre (2); and
a detection algorithm arranged to analyse the accelerometer signal, thereby detecting tyre vibration indicating the end of the life of the tyre (2).

2. The system (1) according to claim 1, wherein the first indicator (4) and the second indicator (4) are not diametrically opposite.

3. The system (1) according to claim 1, wherein the angular separation of the first indicator (4) and the second indicator (4) on the circumference of the tyre (2) deviates from 180 degrees by at least 10 degrees, or by at least 20 degrees or 30 degrees.

4. The system (1) according to claim 1, wherein the detection algorithm is based on a frequency analysis, and/or comprises an artificial intelligence module, and/or comprises a filter.

5. The system (1) according to claim 4, wherein the artificial intelligence network comprises an artificial neural network, and/or the filter is a Kalman filter.

6. The system (1) according to claim 1, wherein the accelerometer signal is a substantially periodic signal when the vehicle is moving at a substantially constant speed.

7. The system (1) according to claim 1, wherein the accelerometer signal has a set of features, such as a set of peaks, indicating the vibration of the tyre (2), and the detection algorithm is arranged to analyse the accelerometer signal in order to detect the set of features thus detecting the vibration of the tyre, and/or wherein the accelerometer (7) is integrated into the valve of the tyre (2).

8. The system (1) according to claim 1, wherein the first indicator (4) is characterised by a first hardness, the second indicator (4) is characterised by a second hardness, and the tread (3) is characterised by a third hardness, wherein the first hardness and/or the second hardness is/are at least 5%, or more specifically at least 15% or 30% greater than the third hardness.

9. The system (1) according to claim 1, wherein the first indicator (4) and/or the second indicator (4) forms/form an element within the material of the tyre (2), and which is not exposed on the tread (3) when the tyre (2) is in a new state, and wherein the element has different mechanical properties to the tread (3).

10. The system (1) according to claim 1, wherein the first indicator (4) and the second indicator (4) are placed in a groove (6) of a tread (3) of the tyre (2).

11. The system (1) according to claim 10, wherein the first indicator (4) and/or the second indicator (4) comprises/comprise a coating forming a layer that is harder than the inner part of the respective indicator.

12. The system (1) according to claim 11, wherein the coating contains a resinous substance.

13. The system (1) according to claim 10, wherein the first indicator (4) and/or the second indicator (4) is/are one or more overmoulded elements.

14. The system (1) according to claim 1, wherein the accelerometer (7) comprises wireless communication means for transmitting the detection result to an autonomous control module.

15. A method for detecting the end of life of a tyre (2) of a vehicle using the tyre monitoring system (1) according to claim 1, which method comprises:
analysing, using the detection algorithm, the accelerometer signal and detecting the vibration of the tyre (2) indicating the end of life of the tyre (2); and
transmitting the result of the detection using wireless communication means to an autonomous control module.
